(19) United States
(12) Patent Application Publication
(10) Pub. No.: US 2014/0109823 A1
(43) Pub. Date: Apr. 24, 2014

(54) Tank Pressure Indicator

(71) Applicant: QUANTUM FUEL SYSTEMS TECHNOLOGIES WORLDWIDE,, Lake Forest, CA (US)

(72) Inventor: Mark Leavitt, Laguna Hills, CA (US)

(73) Assignee: QUANTUM FUEL SYSTEMS TECHNOLOGIES WORLDWIDE, INC., Lake Forest, CA (US)

(21) Appl. No.: 13/656,949

(22) Filed: Oct. 22, 2012

(51) Int. Cl. G01L 19/10

(52) U.S. Cl. 116/268

(57) ABSTRACT

A pressure indicator system is provided for use a gas storage container. The gas storage container has an interior that stores gas, and a housing having a cavity that opens to atmosphere and which communicates with the interior of the container. A piston or diaphragm communicates with a stem that extends through the cavity and into atmosphere, with the stem having a pressure indicator provided around an upper portion of the stem. A resilient element is retained in the cavity and normally biases the piston or diaphragm towards the interior of the container. The existence of pressure in the container opposes the normal bias of the resilient element to cause the stem and its pressure indicator to extend outside the cavity.

### BACKGROUND OF THE INVENTION

1. Field of the Invention

The present invention relates to pressure indicators, and in particular, to a pressure indicator that can be used to indicate the presence of potentially-dangerous pressure inside a tank or other container that holds natural gas or any other gas.

2. Description of the Prior Art

Gaseous fuels are becoming more common as energy sources. Examples include hydrogen and compressed natural gas (CNG), which have been used to power vehicles. As such, there is a need for high pressure storage being required to meet the energy density requirements for such gaseous fuels. Much of the text could be the same with the substitution of “fuel gases” for “hydrogen”.

However, the storage of fuel gases can be challenging. Currently, fuel gases are stored in high pressure containers or vessels. These vessels must be large and are subject to stresses and strains during each pressurization cycle, leading to material fatigue and a reduction in strength. These vessels include a valve through which the gas can be delivered.

Recently, a fatality occurred when an individual removed the valve of a CNG storage vessel that was still under pressure. Other injuries and deaths have occurred while people have worked on pressure vessels under the mistaken assumption that the vessel has been depressurized.

In this regard, conventional fuel gas storage vessels are not equipped with a gauge. Instead, they have a pressure transducer that sends a signal to the fuel gauge, but in the case involving the fatality, it was probably not used. Once the storage vessel is removed from the vehicle, the transducer is not usable without special equipment. In addition, transducers are also quite often placed on an outlet port of the valve and does not indicate internal pressure when the valve is closed.

Servicing of pressure vessels can present a high risk to personnel and property if not depressurized properly prior to servicing or disposal. Current methods for creating safe conditions for servicing pressure vessels are based on procedural instructions for depressurization. However, these do not provide a positive or clear indicator that the vessel has truly been depressurized, or that the procedures were followed accurately.

Thus, there still remains a need to properly warn an individual that a pressure vessel has not been completely depressurized.

### SUMMARY OF THE DISCLOSURE

It is an object of the present invention to provide an indicator that clearly warns an individual that a pressure vessel or container has not been completely depressurized.

In order to accomplish the objects of the present invention, a pressure indicator system is provided for use with a gas storage container. The gas storage container has an interior that stores gas, and a housing having a cavity that opens to atmosphere and which communicates with the interior of the container. A piston or diaphragm communicates with a stem that extends through the cavity and into atmosphere, with the stem having a pressure indicator provided around an upper portion of the stem. A resilient element is retained in the cavity and normally biases the piston or diaphragm towards the interior of the container. The existence of pressure in the container opposes the normal bias of the resilient element to cause the stem and its pressure indicator to extend outside the cavity. In this regard, the present invention provides a visible indicator at the point of danger without requiring the use of external equipment.

### BRIEF DESCRIPTION OF THE DRAWINGS

FIG. 1 is a perspective view of a container that can be used with the pressure indicator system of the present invention.

FIG. 2 is a cross-sectional view of one embodiment of the pressure indicator system according to the present invention.

FIG. 3 is a cross-sectional view of another embodiment of the pressure indicator system according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

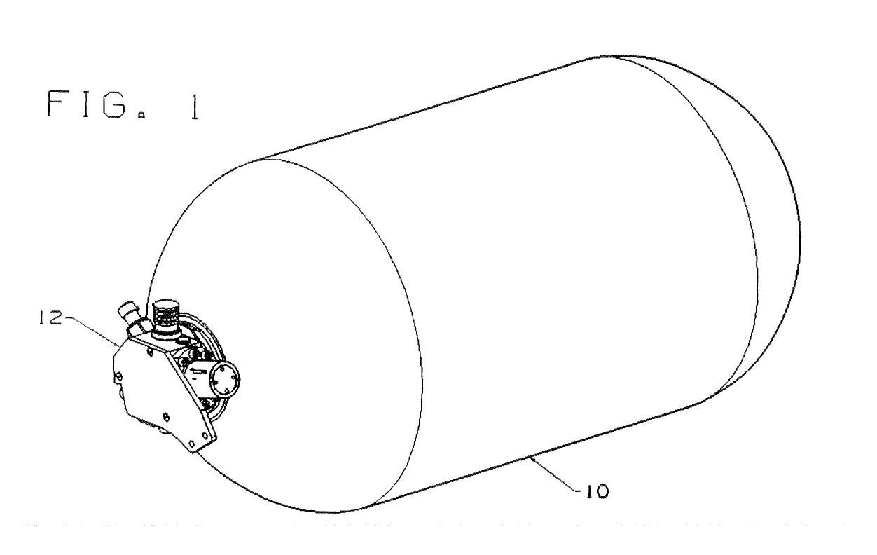

FIG. 1 illustrates a container 10 that can be filled with any known fuel gas (e.g., hydrogen, CNG, or other gas). The container 10 can be placed on-board a vehicle that utilizes a fuel gas for fuel. As a non-limiting example, a typical container 10 for on-board hydrogen storage is designed to have a rated pressure of about 5000 to 10,000 psi. A valve assembly 12 is provided at one end of the container 10, as is well-known in the art.

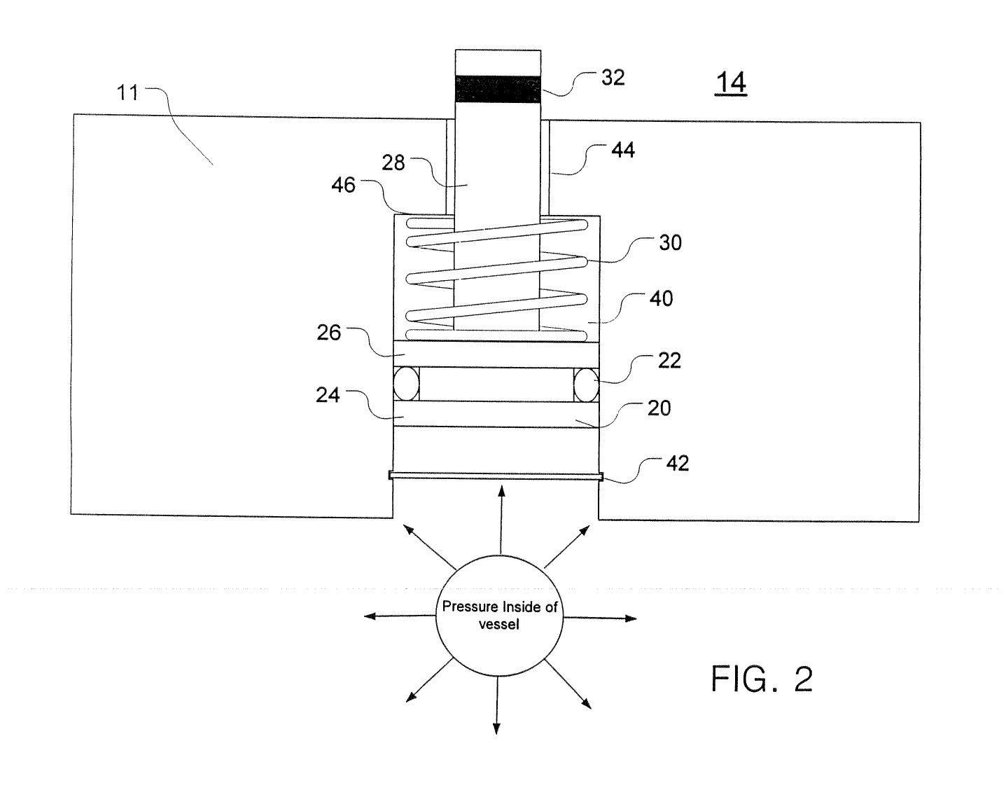

The container 10 and the valve assembly 12 can be constructed in a manner similar to conventional containers and valves, except that the container 10 is provided with a pressure indicator system 14, as shown in FIG. 2. The pressure indicator system 14 can be provided in a housing 11, which can be the body of the container 10, as part of the valve assembly 12, or in a fitting that is incorporated with the container 10.

The pressure indicator system 14 utilizes a piston 20 that has a seal 22 (e.g., an O-ring) positioned about a circumferential channel defined by the two walls 24 and 26 of the piston 20. A shaft or stem 28 extends from the top of the upper wall 26, and a resilient element 30 (e.g., a spring) is provided around the stem 28. A pressure indicator 32 is wrapped around an upper portion of the stem 28. The pressure indicator 32 should be a simple element that attracts attention, such as a red-colored band, so that the user can quickly and easily see that pressure still remains in the container 10.

The piston 20 and its stem 28 are positioned inside a cavity 40 provided in the housing 11 of the fitting, valve assembly 12 or wall of the container 10. A retaining ring 42 is provided adjacent the inner-most part of the cavity 40 (i.e., adjacent the interior of the container 10 where the gas is stored) to prevent the piston 20 from being pushed into the container 10. In addition, the cavity 40 is shaped so that it has a narrowed neck region 44 that receives the stem 28, so that the upper wall 26 of the piston 20 cannot extend into the neck region 44. In addition, the resilient element 30 abuts against the shoulder 46 of the neck region 44.

The operation of the pressure indicator system 14 is simple. If the container 14 contains gas, the pressure inside the container 10 will push the piston 20 upwardly (as viewed in the orientation of FIG. 2) in the cavity 40 against the natural bias of the resilient element 30, so that the stem 28 becomes exposed, with the pressure indicator 32 being clearly visible to warn the user that pressurized gas is still inside the container 10.

If the container 10 has been emptied, or contains no more gas, then the natural bias of the resilient element 30 will push the piston 20 downwardly (as viewed in the orientation of FIG. 2) towards the retaining ring 42, so that the stem 28 is retracted into the narrowed neck region 44 such that the pressure indicator 32 is no longer visible. This tells the user that the container 10 does not contain any more gas, or that the amount of gas left in the container 10 is at a non-dangerous level.

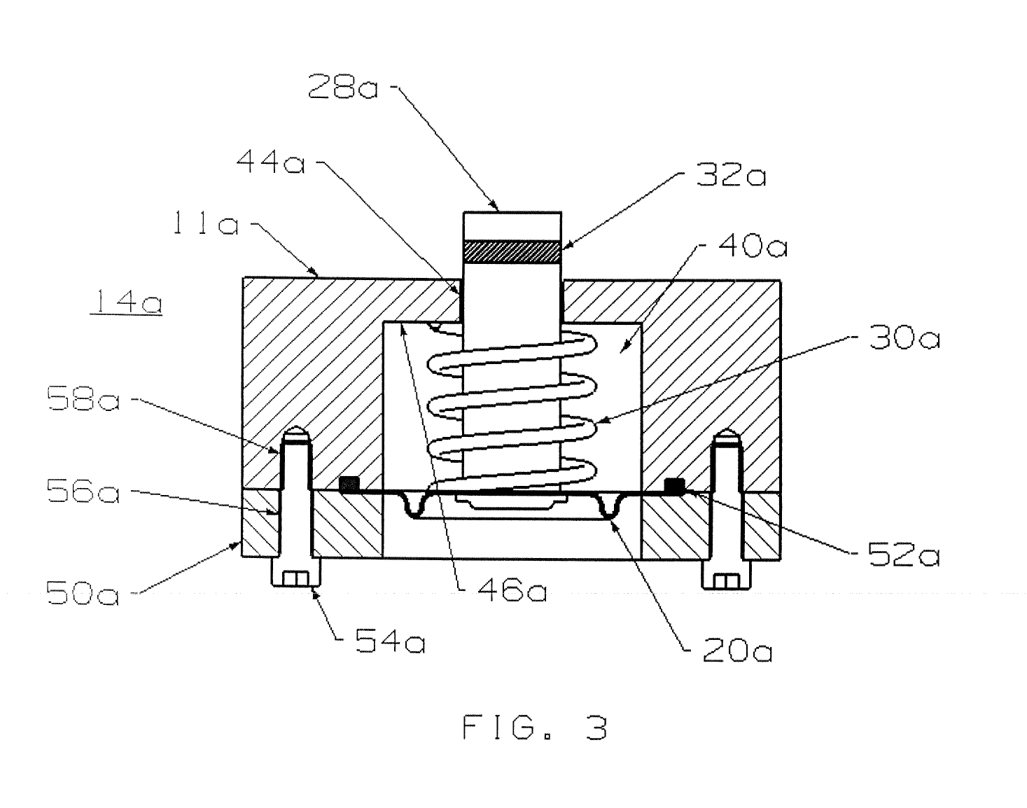

FIG. 3 illustrates a pressure indicator system 14a according to another embodiment of the present invention. The pressure indicator system 14a utilizes a diaphragm 20a instead of the piston 20. The pressure indicator system 14a also includes a stem 28a and a resilient element 30a that can be the same as the stem 28 and the resilient element 30, respectively, for FIG. 2 above. A pressure indicator 32a is also wrapped around an upper portion of the stem 28a. The stem 28a and the resilient element 30a are also retained in a cavity 40a in the housing 11a. The cavity 40a is also shaped so that it has a narrowed neck region 44a that receives the stem 28a, and the resilient element 30a abuts against the shoulder 46a of the neck region 44a.

Instead of a piston, the embodiment of FIG. 3 has a diaphragm 20a that is secured to the housing 11a by a diaphragm retainer 50a. The edge of the diaphragm 20a is secured to a seal 52a between the housing 11a and the retainer 50a, and a bolt 54a extends through aligned openings 56a and 58a in the retainer 50a and the housing 11a, respectively, to secure the diaphragm 20a at the base of the cavity 40a between the housing 11a and the retainer 50a.

The operation of the pressure indicator system 14a is similar to the system 14 of FIG. 2. If the container 14 contains gas, the pressure inside the container 10 will push the diaphragm 20a upwardly (as viewed in the orientation of FIG. 3) in the cavity 40a against the natural bias of the resilient element 30a, so that the stem 28a becomes exposed, with the pressure indicator 32a being clearly visible to warn the user that pressurized gas is still inside the container 10a.

If the container 10 has been emptied, or contains no more gas, then the natural bias of the resilient element 30a will push the stem 28a downwardly (as viewed in the orientation of FIG. 3) towards the diaphragm 20a, so that the stem 28a is retracted into the narrowed neck region 44a such that the pressure indicator 32a is no longer visible. This tells the user that the container 10 does not contain any more gas, or that the amount of gas left in the container 10 is at a non-dangerous level. This will indicate to the user that it is safe to remove valves or fittings.

The pressure indicator systems 14, 14a of the present invention can be used for any pressure vessel or container (gas or liquid). They offer a number of benefits. First, the pressure indicator systems 14, 14a of the present invention are simple to use, and do not require secondary tools or equipment to determine if the container 10 is pressurized. Second, no special training is required for a user to use the present invention. Third, pressure indicator systems 14, 14a of the present invention provide a quick, easily-visible and simple warning to warn emergency personnel or any user that the container 10 is still pressurized.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A pressure indicator system for use a gas storage container, comprising:
a gas storage container having an interior that stores gas, a housing having a cavity that opens to atmosphere and which communicates with the interior of the container;
a piston positioned inside the cavity, with a stem coupled to the piston and extending through the cavity and into atmosphere, the stem having a pressure indicator provided around an upper portion of the stem;
a resilient element retained in the cavity and normally biasing the piston towards the interior of the container;
a retaining ring is provided in the cavity adjacent the interior of the container to prevent the piston from being pushed into the interior of the container; and
wherein the existence of pressure in the container opposes the normal bias of the resilient element to cause the piston to move outwardly in the cavity and thereby cause the stem and its pressure indicator to extend outside the cavity.

2. The system of claim 1, wherein the cavity is shaped so that it has a narrowed neck region that receives the stem, so that the piston is prevented from extending into the neck region.

3. The system of claim 2, wherein the neck region defines a shoulder, and the resilient element abuts against the shoulder of the neck region.

4. The system of claim 1, wherein the housing can be the body of the container, as part of a valve assembly associated with the container, or in a fitting that is incorporated with the container.

5. The system of claim 1, wherein the piston includes a seal.

6. The system of claim 1, wherein the pressure indicator is wrapped around an upper portion of the stem in a manner which renders it clearly visible to a user.

7. A pressure indicator system for use a gas storage container, comprising:
a gas storage container having an interior that stores gas, a housing having a cavity that opens to atmosphere and which communicates with the interior of the container;
a diaphragm positioned at the base of the cavity, the diaphragm communicating with a stem that extends through the cavity and into atmosphere, the stem having a pressure indicator provided around an upper portion of the stem;
a resilient element retained in the cavity and normally biasing the piston towards the interior of the container;
a retainer coupled to the housing to secure the diaphragm at the base of the cavity; and
wherein the existence of pressure in the container opposes the normal bias of the resilient element to cause the diaphragm to move towards the cavity and thereby cause the stem and its pressure indicator to extend outside the cavity.

8. The system of claim 7, wherein the neck region defines a shoulder, and the resilient element abuts against the shoulder of the neck region.

9. The system of claim 7, wherein the housing can be the body of the container, as part of a valve assembly associated with the container, or in a fitting that is incorporated with the container.

10. The system of claim 7, wherein the pressure indicator is wrapped around an upper portion of the stem in a manner which renders it clearly visible to a user.
